(19) United States
(12) Patent Application Publication
(10) Pub. No.: US 2022/0384066 A1
(43) Pub. Date: Dec. 1, 2022

(54) Zero-Buoyancy Cable and Deep-Sea Equipment

(71) Applicant: OCEAN UNIVERSITY OF CHINA, Qingdao City (CN)

(72) Inventors: Jinhui Dai, Qingdao City (CN); Xin Wang, Qingdao City (CN); Pingwei Wu, Qingdao City (CN)

(21) Appl. No.: 17/589,513

(22) Filed: Jan. 31, 2022

(30) Foreign Application Priority Data
May 27, 2021 (CN) 202110582980.0

(51) Int. Cl. H01B 7/12; H01B 7/14; H01B 7/282

(52) U.S. Cl. CPC H01B 7/12; H01B 7/14; H01B 7/2825

(57) ABSTRACT

The present application provides a zero-buoyancy cable, which comprises a cable; a plurality of floats sheathed on the cable; and a cladding layer configured to tightly wrap the plurality of floats and the cable so as to fix the floats onto the cable. The zero-buoyancy cable provided in the present application can effectively avoid the loss of the float or the sliding of the float on the cable, thereby improving the balance of the zero-buoyancy cable in the water.

### FIELD OF THE INVENTION

This application relates to the field of electric power technology, in particular to a zero-buoyancy cable and deep-sea equipment.

### BACKGROUND OF THE INVENTION

The zero-buoyancy cable neither sinks nor floats in the water, which effectively reduces the influence of gravity or buoyancy generated by the cable on the underwater equipment and is widely used in the underwater equipment. In deep-sea oil and gas exploration, the safety of deep-sea umbilical cables connecting surface floating devices and subsea equipment is of vital importance, but commercial zero-buoyancy cables are mostly suitable for shallow sea areas with seawater depths less than 300 meters. Currently, zero-buoyancy cables are mainly prepared by two methods as follows. The first one is to set foamed materials on the outer layer of the cable, and most of them are polyethylene foamed materials. However, the water pressure that the foamed materials can withstand is small, and thus such a zero-buoyancy cable is mostly used in shallow sea areas with the sea depth less than 300 meters. The second one is to fix the buoyant material on the periphery of the cable by binding or locking, and high-strength buoyant materials may be selected to achieve deep-sea applications with a depth of several kilometers. However, under the action of seawater corrosion, impact or other external forces, the zero-buoyancy cable made by float binding or locking is prone to binding or locking failure and thus a single floating body is formed, or the float has obvious displacement in the length direction of the cable, which affects the balance of the cable and causes the cable to bend and fail to work normally.

### SUMMARY OF THE INVENTION

The purpose of the embodiments in the present application is to provide a zero-buoyancy cable and deep-sea equipment to avoid the loss of floats on the zero-buoyancy cable or sliding of the floats on the cable, thereby improving the balance of the zero-buoyancy cable in the water. The specific technical solutions are as follows.

The first aspect of the present application provides a zero-buoyancy cable, which comprises:

a cable;

a plurality of floats sheathed on the cable; and

a cladding layer, configured to tightly wrap the plurality of floats and the cable so as to fix the floats onto the cable.

In some embodiments of the present application, the zero-buoyancy cable further comprises a plurality of isolation pads sheathed on the cable, each of which is arranged between two adjacent floats.

In some embodiments of the present application, the isolation pad is an elastic isolation pad.

In some embodiments of the present application, the outer diameter of the isolation pad is less than or equal to the outer diameter of the float.

In some embodiments of the present application, the difference between the outer diameter and the inner diameter of the isolation pad is greater than the difference between the inner diameter of the float and the outer diameter of the cable.

In some embodiments of the present application, the float is cylindrical, prismatic, or spindle-shaped.

In some embodiments of the present application, the difference between the inner diameter of the float and the outer diameter of the cable is not more than 10 mm.

In some embodiments of the present application, the float comprises a buoyant material, and the buoyant material comprises a composite of epoxy resin and hollow glass microbeads.

In some embodiments of the present application, the cladding layer has a thickness of 0.5 mm to 2 mm.

In some embodiments of the present application, the cladding layer is made of any one or more selected from the group consisting of a heat shrinkable tube, a cold shrinkable tube, a rubber tube, a heat shrinkable tape, a cold shrinkable tape and a rubber tape.

The second aspect of the present application provides a deep-sea equipment, comprising the zero-buoyancy cable in any of the above-mentioned embodiments.

In the zero-buoyancy cable provided in the application, the float is sheathed on the outside of the cable without additional reinforcement and the float will not be lost. Meanwhile, the cladding layer is tightly wrapped around the cable and the float, so that the cable and the float form a whole. Relative sliding is not easy to occur between the float and the cable, and the float will not be lost due to external force, so that the cable has good balance and is not easy to bend, which is capable of ensuring the normal operation of the cable.

Of course, implementing the product or method of any embodiment in the present application does not necessarily need to achieve all the advantages described above at the same time.

### BRIEF DESCRIPTION OF THE DRAWINGS

In order to more clearly describe the technical solutions in the embodiments of the present application or the prior art, the drawings that need to be used in the description of the embodiments or the prior art will briefly introduced below. Obviously, the drawings in the following description are only some embodiments of the present application. For those skilled in the art, other embodiments can be obtained according to these drawings.

FIG. 1 is a cross-sectional view of a zero-buoyancy cable according to some embodiments of the application;

FIG. 2 is a schematic diagram of a zero-buoyancy cable that does not include a cladding layer in some embodiments of the application.

### DETAILED DESCRIPTION OF THE INVENTION

The technical solutions in the embodiments of the present application will be clearly and completely described below in conjunction with the drawings in the embodiments of the present application. It is obvious that the described embodiments are only a part of the embodiments of the application, rather than all the embodiments thereof. Based on the embodiments in the application, those skilled in the art can obtain all other embodiments that fall within the scope of the application based on the present application.

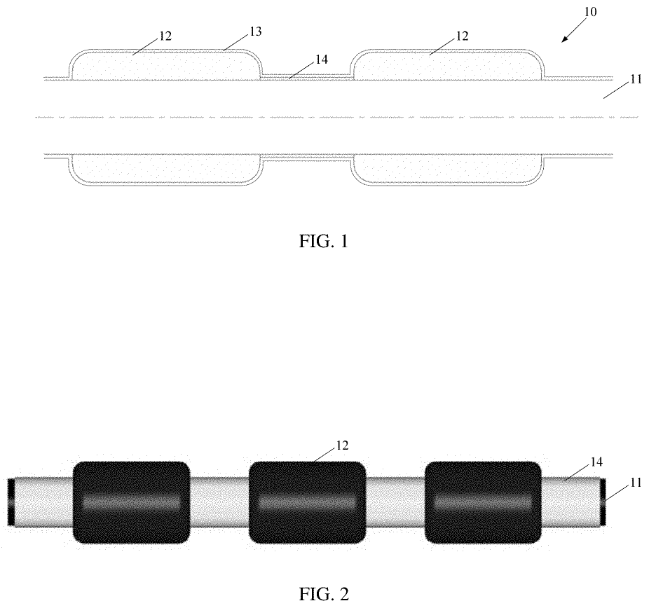

As shown in FIGS. 1 and 2, the first aspect of the present application provides a zero-buoyancy cable 10, which comprises:

a cable 11;

a plurality of floats 12 sheathed on the cable 11; and

a cladding layer 13, configured to tightly wrap the plurality of floats 12 and the cable 11 so as to fix the floats 12 onto the cable 11.

In the zero-buoyancy cable 10 provided by the present application, the float 12 is sheathed on the outside of the cable 11 without additional reinforcement and the float 12 will not be lost. Meanwhile, the cladding layer 13 is tightly wrapped around the cable 11 and the float 12, so that the cable 11 and the float 12 form a whole. Relative sliding is not easy to occur between the float 12 and the cable 11, and the float 12 will not be lost due to external force, so that the cable 11 has good balance and is not easy to bend, which is capable of ensuring the normal operation of the cable 11, and can be applied to the deep sea with a maximum depth of 10,000 meters.

In the present application, the cladding layer is not particularly limited, as long as the purpose of the application can be achieved. For example, the cladding layer may be, but is not limited to, formed of any one or more selected from the group consisting of a heat shrinkable tube, a cold shrinkable tube, a rubber tube, a heat shrinkable tape, a cold shrinkable tape, and a rubber tape. The size of the heat shrinkable tube, the cold shrinkable tube, the rubber tube, the heat shrinkable tape, the cold shrinkable tape or the rubber tape is not particularly limited in the application, and can be selected according to the outer diameter of the float 12. The heat shrinkable tube refers to a sleeve that can shrink when heated, and maintains the expanded state formed during the preparation process at normal temperature, and can be retracted by heating it during use. The cold shrinkable tube refers to a sleeve that can be contracted at normal temperature, including the cold shrinkable sleeve and the spiral support that supports the cold shrinkable sleeve. The spiral support is drawn out during use, and the cold-shrinkable sleeve can be retracted by elasticity at normal temperature. The principle of the heat shrinkable tape is similar to that of the heat shrinkable tube, but the shape is different; the principle of the cold shrinkable tape is similar to that of the cold shrinkable tube, but the shape is different.

In the present application, the thickness of the cladding layer is not particularly limited, as long as the purpose of the application can be achieved. For example, the cladding layer has a thickness of 0.5 mm to 2 mm. In the application, the thickness of the cladding layer refers to the thickness of the cladding layer covering the float and the isolation pad.

As shown in FIG. 1, in some embodiments of the application, the zero-buoyancy cable 10 further comprises a plurality of isolation pads 14 sheathed on the cable 11, and each isolation pad 14 is arranged between two adjacent floats 12. The arrangement of the isolation pad 14 enables a stable distance between two adjacent floats 12 to be maintained, thereby further improving the structural stability of the zero-buoyancy cable 10.

In some embodiments of the application, the isolation pad 14 is an elastic isolation pad, which facilitates winding or bending of the zero-buoyancy cable 10. The application has no special restrictions on the material of the elastic isolation pad 14, as long as the purpose of the application can be achieved. For example, the material of the elastic isolation pad 14 may be, but is not limited to, polyurethane or silicon rubber.

In some embodiments of the application, the outer diameter of the isolation pad 14 is less than or equal to that of the float 12. Since the difference between the outer diameter and the inner diameter of the float 12 is usually large and the isolation pad 14 is mainly used to separate two adjacent floats 12, the outer diameter of the isolation pad 14 may be smaller than that of the float 12, thereby reducing the total mass of the zero-buoyancy cable 10.

In the present application, the isolation pad 14 and the cable 11 may be tightly attached with no gap, so as to prevent the isolation pad 14 from slipping on the cable 11. There may also be a certain gap to facilitate the isolation pad 14 to be sheathed on the cable 11.

In some embodiments of the application, the difference between the outer diameter and the inner diameter of the isolation pad 14 is greater than the difference between the inner diameter of the float 12 and the outer diameter of the cable 11. Therefore, when there is a gap between the float 12 and the cable 11, the isolation pad 14 is prevented from slipping along the cable and partially or completely overlapping with the float 12, thereby affecting the distance between two adjacent floats 12.

In the present application, the length of the isolation pad along the length of the cable is not particularly limited, and it can be selected according to the outer diameter of the cable. Specifically, when the outer diameter of the cable is small, the bending radius required for winding is also smaller, which requires a longer isolation pad; when the outer diameter of the cable is larger, the bending radius required for winding is larger, and the length of the isolation pad can be appropriately reduced. For example, the ratio of the length of the isolation pad along the length of the cable to the outer diameter of the cable is 1:5 to 5:1.

In the present application, the float 12 and the cable 11 can be closely attached with no gap, so as to prevent the float 12 from sliding on the cable 11. There can also be a certain gap to facilitate the float 12 to be sheathed on the cable 11. Preferably, the difference between the inner diameter of the float 12 and the outer diameter of the cable 11 is not more than 10 mm. In the application, the size of the inner diameter of the float 12 is not particularly limited, and it can be selected according to the outer diameter of the cable 11.

In the application, the length of the float along the length of the cable is not particularly limited, and it can be selected according to the outer diameter of the cable. Specifically, when the outer diameter of the cable is smaller, the bending radius required for winding is also smaller, so a float with a smaller length is required; when the outer diameter of the cable is larger, the bending radius required for winding is larger. The length of the float can also be appropriately increased. For example, the ratio of the length of the float along the length of the cable to the outer diameter of the cable is 1:1 to 6:1.

In the present application, the shape of the float 12 is not particularly limited, as long as the purpose of the present application can be achieved. For example, the shape of the float 12 may be, but is not limited to, cylindrical, prismatic, or spindle shaped. The float 12 has a symmetrical structure, which is beneficial to improve the balance of the zero-buoyancy cable 10.

In some embodiments of the application, the float comprises a buoyant material, and there is no special restriction on the buoyant material in the present application, as long as the purpose of the present application can be achieved. For example, the density of the buoyancy material is less than 1 g/cm³, and the compressive strength is greater than or equal to 50 MPa. Preferably, the buoyancy material includes a composite of epoxy resin and hollow glass microbeads. It is understood that the buoyancy material can be selected according to the depth of use of the zero-buoyancy cable in the water.

In the present application, the method of producing the zero-buoyancy cable is not particularly limited, as long as the purpose of the application can be achieved. For example, the method of producing a zero-buoyancy cable may include but is not limited to the following steps: sleeving the float and the isolation pad on the cable, and then sleeving the heat shrinkable tube on them, heating the heat shrinkable tube with a heat gun to shrink it, so that the float and the isolation pad is tightly wrapped on the cable to obtain a zero-buoyancy cable.

Specifically, the zero-buoyancy cables 1-8 are shown in Table 1, wherein the heat shrinkable tube is a polyethylene heat shrinkable tube, and the thickness of the cladding layer formed by the polyethylene heat-shrinkable tube on the float is 0.1 cm. The parameters of the cable, the float and the isolation pad are shown in Table 1. It should be noted that the zero-buoyancy cable in Table 1 is used as an example to explain the application, but the zero-buoyancy cable in the application is not limited to the zero-buoyancy cable shown in Table 1.

TABLE 1

| | | | | | | | | | Total |
|---|---|---|---|---|---|---|---|---|---|
| | | Outer | | | | | Inner | Outer | density |
| | | diameter | | Inner | Outer | Length of | diameter of | diameter of | of zero- |
| | Cable | of the | Float | diameter | diameter | isolation | isolation | isolation | buoyancy |
| | specifications | cable | length | of float | of float | pad | pad | pad | cable |
| | (mm²) | (cm) | (cm) | (cm) | (cm) | (cm) | (cm) | (cm) | (g/cm³) |
| Zero- | 120 | 1.045 | 5 | 1.09 | 4 | 5 | 1.09 | 1.24 | 1074.54 |
| buoyancy | | | | | | | | | |
| cable 1 | | | | | | | | | |
| Zero- | 150 | 1.140 | 5 | 1.19 | 5 | 5 | 1.19 | 1.34 | 1018.54 |
| buoyancy | | | | | | | | | |
| cable 2 | | | | | | | | | |
| Zero- | 185 | 1.255 | 5 | 1.30 | 5.5 | 5 | 1.30 | 1.45 | 1059.35 |
| buoyancy | | | | | | | | | |
| cable 3 | | | | | | | | | |
| Zero- | 240 | 1.395 | 5 | 1.44 | 6 | 5 | 1.44 | 1.59 | 1040.82 |
| buoyancy | | | | | | | | | |
| cable 4 | | | | | | | | | |
| Zero- | 300 | 1.525 | 5 | 1.57 | 6.5 | 5 | 1.57 | 1.72 | 1078.05 |
| buoyancy | | | | | | | | | |
| cable 5 | | | | | | | | | |
| Zero- | 400 | 1.695 | 8 | 1.74 | 6.5 | 3 | 1.74 | 1.89 | 1050.32 |
| buoyancy | | | | | | | | | |
| cable 6 | | | | | | | | | |
| Zero- | 500 | 1.880 | 10 | 1.93 | 7.0 | 3 | 1.93 | 2.08 | 1084.78 |
| buoyancy | | | | | | | | | |
| cable 7 | | | | | | | | | |
| Zero- | 630 | 2.095 | 10 | 2.14 | 7.5 | 2.5 | 2.14 | 2.29 | 1067.46 |
| buoyancy | | | | | | | | | |
| cable 8 | | | | | | | | | |

The second aspect of the present application provides a deep-sea equipment, including the zero-buoyancy cable in any of the above-mentioned embodiments, which can be applied to the deep sea with a maximum depth of 10,000 meters. The aforementioned deep-sea equipment may be, but not limited to, deep-sea oil and gas exploration equipment, deep-sea exploration equipment, and the like.

It should be noted that the term “including” or any other variant thereof as described herein is intended to cover non-exclusive inclusion, so that a method or article that includes a series of elements not only includes those elements, but also includes other elements that are not explicitly listed, or also includes elements inherent to this method or article.

The various embodiments in the specification are described in a related manner, and the same or similar parts between the various embodiments can be referred to each other, and each embodiment focuses on the differences from other embodiments.

The above descriptions are only preferred embodiments of the present application, and are not used to limit the scope of the present application. Any modification, equivalent replacement, improvement and so on made within the spirit and principle of the application are all included in the scope of the application.

This application is supported by the “Fundamental Research Funds for the Central Universities, No. 201964010”.

1. A zero-buoyancy cable, comprising:
a cable;
a plurality of floats sheathed on the cable; and
a cladding layer, configured to tightly wrap the plurality of floats and the cable so as to fix the floats onto the cable.

2. The zero-buoyancy cable according to claim 1, further comprising a plurality of isolation pads sheathed on the cable, each of which is arranged between two adjacent floats.

3. The zero-buoyancy cable according to claim 2, wherein the isolation pad is an elastic isolation pad.

4. The zero-buoyancy cable according to claim 2, wherein the outer diameter of the isolation pad is less than or equal to the outer diameter of the float.

5. The zero-buoyancy cable according to claim 2, wherein the difference between the outer diameter and the inner diameter of the isolation pad is greater than the difference between the inner diameter of the float and the outer diameter of the cable.

6. The zero-buoyancy cable according to claim 1, wherein the float is cylindrical, prismatic or spindle-shaped.

7. The zero-buoyancy cable according to claim 1, wherein the difference between the inner diameter of the float and the outer diameter of the cable is not more than 10 mm.

8. The zero-buoyancy cable according to claim 1, wherein the float comprises a buoyancy material, and the buoyancy material comprises a composite of epoxy resin and hollow glass microbeads.

9. The zero-buoyancy cable according to claim 1, wherein the cladding layer has a thickness of 0.5 mm to 2 mm.

10. The zero-buoyancy cable according to claim 1, wherein the cladding layer is made of any one or more selected from the group consisting of a heat shrinkable tube, a cold shrinkable tube, a rubber tube, a heat shrinkable tape, a cold shrinkable tape and a rubber tape.

11. A deep-sea equipment comprising the zero-buoyancy cable according to claim 1.
